(19) United States
(12) Patent Application Publication
(10) Pub. No.: US 2010/0058120 A1
(43) Pub. Date: Mar. 4, 2010

(54) Dynamic Inline Sequence Interface

(75) Inventors: Kenneth P. Coleman, Bothell, WA (US); Joseph W. Hallock, Renton, WA (US); Terrance C. Kirkwood, Seattle, WA (US); Christer Garbis, Kirkland, WA (US); Edward K. Tremblay, Bellevue, WA (US); Dmitry Sonkin, Redmond, WA (US); Michael D. Lubrecht, Carnation, WA (US); Jeanine E. Spence, Kenmore, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/198,881

(22) Filed: Aug. 26, 2008

(51) Int. Cl. G06F 9/46; G06F 3/048; G06F 11/32

(52) U.S. Cl. 714/57; 715/772; 718/106; 714/E11.188

(57) ABSTRACT

A user interface displays multiple steps in sequential relationship to each other, and may group various steps together and provide completion indicators for each step as well as an overall completion indicator. Error conditions, status information, queries, and details about a particular step or group of steps may be displayed inline with the steps in a task detail portion of the user interface. The task detail portion may be collapsible and expandable by the user. Progress and completion indicators may be updated for each step, groups of steps, and the overall sequence. In a typical use, a software installation sequence may comprise installation steps from multiple software components. The user interface may illustrate the status of individual tasks, groups of task, and the overall sequence as the tasks are performed, and enable errors to be resolved by displaying queries and other information inline with the steps.

### BACKGROUND

Multi-step, sequential computer operations can become difficult to visualize and manage as the operations become more complex and lengthy. Such an operation may be the installation of a complex system of interacting software components, for example. A user who monitors or manages the operations may have difficulty visualizing the overall operation, and may also wish to have detailed information about individual steps within the operation. Further, many such operations may incur error conditions that may arise during processing that may be corrected and various user interface queries may be used to remediate the condition.

### SUMMARY

A user interface displays multiple steps in sequential relationship to each other, and may group various steps and sub steps together and provide completion indicators for each step as well as an overall completion indicator. Error conditions, status information, queries, and details about a particular step or group of steps may be displayed inline with the steps in a task detail portion of the user interface. The task detail portion may be collapsible and expandable by the user. Progress and completion indicators may be updated for each step, groups of steps, and the overall sequence. In a typical use, a software installation sequence may comprise installation steps from multiple software components. The user interface may illustrate the status of individual tasks, groups of task, and the overall sequence as the tasks are performed, and enable errors to be resolved by displaying queries and other information inline with the steps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing an environment in which an installation system may operate.

FIG. 2 is a diagram illustration of an embodiment showing functional components of an installation system.

FIG. 3 is a flowchart illustration of an embodiment showing a method for generating a user interface.

FIG. 4 is a flowchart illustration of an embodiment showing a method for a runtime operation.

FIG. 5 is a flowchart illustration of an embodiment showing a method for monitoring completion of workloads.

FIG. 6 is a flowchart illustration of an embodiment showing a method for processing user input to an expand/contract button.

FIG. 7 is a flowchart illustration of an embodiment showing a method for processing an error indication.

FIG. 8 is a diagram illustration of an embodiment showing a user interface with a detail element.

FIG. 9 is a diagram illustration of an embodiment showing a user interface before and after an error indication is received.

### DETAILED DESCRIPTION

A user interface may display multiple steps in sequence. The steps may be organized in groups and may have mechanisms to display or hide details for each step or group of steps.

In one example of the user interface, a group of software installation steps may be aggregated, grouped, and managed using the user interface. The user interface may enable an administrator to start, stop, and pause the installation steps, as well as display error messages and corrective action options.

Status messages, indicators, error messages, and other indicators may be displayed inline with the step to which the indicators relate. In many embodiments, an expandable portion of the user interface may expand to display the indicators and collapse to hide the indicators. The expandable portion of the user interface may present various user input mechanisms for receiving user selections for options relating to the step, an example of which being the selection of a corrective action in response to an error being detected with one of the steps.

When the user interface is used in a computer software installation, multiple installation and configuration steps for multiple software components may be gathered together. The steps may be organized into a sequence, and the user interface may be used to launch the installation sequence and monitor each step individually, grouped with other steps, and monitor the overall progress of the installation sequence.

In such a use, an error that may be detected may be displayed inline with the affected step, and options for correcting the error may be presented. During operation, an expandable portion may be used to display details about any step, including completed steps, steps in progress, and steps yet to be started.

The status of multiple steps may not be limited to showing completion on a single server and may encompass showing status across multiple devices. For example, installation of a multi server software system can be installed on both a local area network and a public and private wide area network.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

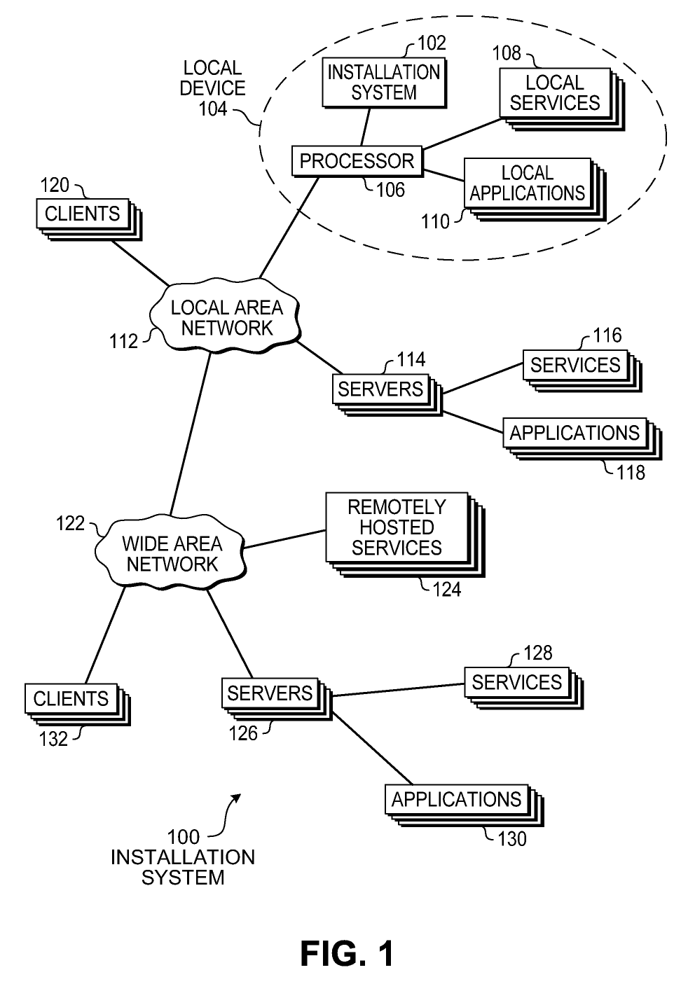

FIG. 1 is a diagram of an embodiment 100 showing an installation system. Embodiment 100 is a simplified example of an installation system that may be used to install and configure various components on a local system, systems connected through a local area network, and systems available through a wide area network.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of an installation system that may manage installation of multiple components over multiple devices. The installation system may gather several workloads, each workload defining an installation or configuration for a particular component. The installation system may coordinate the workloads and cause each workload to be performed in sequence. The installation system may also have a status database in which input parameters for the workloads may be stored.

The installation system 102 may operate on a local device 104. A processor 106 may execute the installation system 102, and may cause various local services 108 and local applications 110 to be installed and configured.

The installation system 102 may also install and configure components across a network, including a local area network 112. Various servers 114 may have multiple services 116 and applications 118 that may be installed and configured. In some embodiments, the installation system 102 may be used to install and configure components on client devices 120.

The installation system 102 may be used to install and configure components across a wide area network 122. The components may include remotely hosted services 124, as well as services 128 and applications 130 that are operable on remote servers 126. The installation system 102 may also install and configure components on remote clients 132 in some cases.

A component that may be installed and configured may include software applications, hardware components, software services, and other configurable components.

For the purposes of this specification, a service may be a mechanism to enable access to one or more capabilities, where the access is provided using a prescribed interface and is exercised consistent with constraints and policies as specified in a service description.

For the purposes of this specification, an application may be a software program or group of software elements that may be used to perform a task that a user wishes to perform. The technical differences between a service and an application are blurry, as some software components may be considered a service when accessed using a browser or another software interface, and the same software component may be considered an application when the component is accessed through a user interface generated by the component. For the purposes of this specification, any reference to a service or application may be considered to include any application, service, or other configurable component, including configurable software, firmware, and hardware components.

The installation system 102 may manage workloads defining an installation or configuration of a component. Each workload may be defined using one or more tasks. A task may be a step within the workload, and many tasks may have specific input parameters and may generate various results.

The input parameters for a task may include information that is solicited from a user interface and provided by a user. In such a case, the installation system 102 may identify those input parameters and may present the input parameters on a user interface and store the values received.

In many embodiments, the installation system 102 may gather many of the input parameters and perform a user interface query for those parameters prior to causing the workloads to be executed. In other cases, the installation system 102 may perform a user interface query for parameters as those parameters are used during workload execution.

When the user interface queries are performed prior to causing the workloads to be executed, the installation system 102 may allow many parameters to be collected prior to launching the workloads. Such an embodiment may be useful when the workloads may take a long time to process. In some instances, installation and configuration operations may take many minutes or even hours to complete. By requesting the input parameters initially, a user may enter the data to be used and allow the installation system 102 to run for a long time without user interaction.

In many embodiments, some workloads may depend on other workloads. For example, the output of one workload may use the results of another workload. In another example, one application or service may use another application or service or may be configured to interoperate with the other application or service. In some cases, the installation system 102 may be able to detect which workloads depend on other workloads. In some cases, a user may indicate dependencies between workloads prior to executing the workloads.

Embodiment 100 is an example of the devices and components that may be affected by the installation system 102. The installation system 102 may act as a centralized mechanism for installing and configuring multiple components over multiple devices. When the installation of such components are centralized, the components may be scheduled based on their dependencies and their installation may be coordinated with respect to the dependencies. Further, information used by multiple components may be shared across the components so that the information is consistent and may be entered once.

The installation system 102 may be used by an administrator to administer installation of services on other devices, including services and applications on server devices as well as client devices. The administrator may manage the configuration of multiple components from a single location and using a single interface, and cause the configuration to occur on other devices, including servers and clients.

In some embodiments, the installation system 102 may operate as a remotely hosted service and may be used to manage the installation and configuration of devices within a local area network. In such an embodiment, the installation system 102 may have a web-based user interface so that an administrator may direct the operation of the installation system 102 with regard to various local client devices.

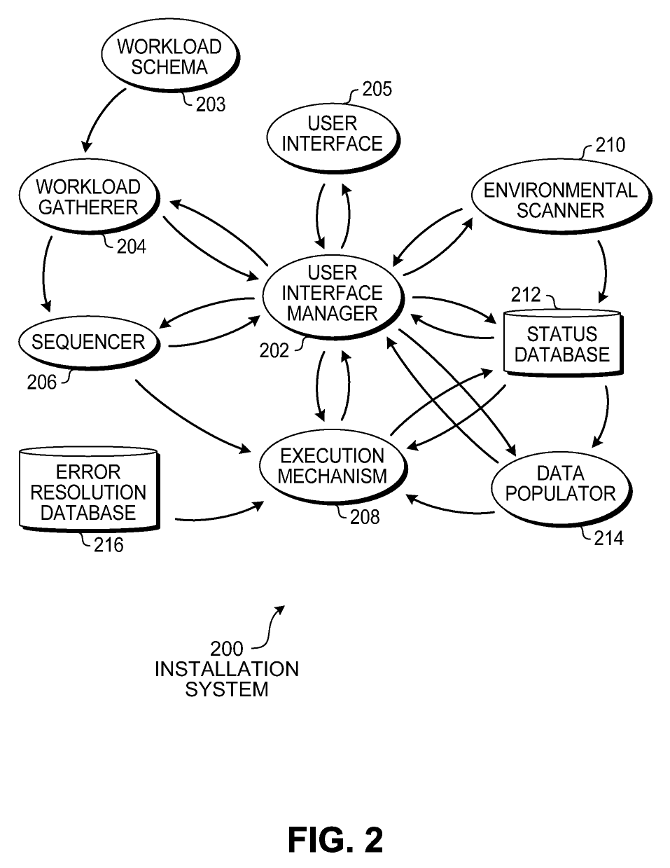

FIG. 2 is a diagram of an embodiment 200 showing an installation system. Embodiment 200 is a simplified example of the functional elements of a workload based installation system that may be used to install and configure various components on a local system, systems connected through a local area network, and systems available through a wide area network.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 is an example of the functional elements that may make up an installation system such as installation system 100 illustrated in embodiment 100. In some embodiments, one or more of the functional elements described may operate on a local device, while other functional elements may operate on different devices, including local servers or remotely hosted services.

Embodiment 200 has a user interface 205 through which a user, such as an administrator, may cause various installation and configuration operations to occur. A typical user interface 205 may be a window on a computer display that may display various information, solicit input, and give status to the user. The user may have various devices such as keyboards, pointing devices, and other indicators to input information to the user interface. In a local console mode, the user interface 205 may be on a console interface to a device that implements the embodiment 200. In a remote or browser mode, the user interface 205 may be accessed using a web browser or other browser software from a remote computer. Other embodiments may have different mechanisms for implementing a user interface 205.

A user interface manager 202 may create elements that are displayed on the user interface 205 and may manage the receipt of input from a user for causing various actions to occur.

The user interface manager 202 may receive descriptions of the various workloads or tasks in summary form and detailed form and display the summary or detailed information on the user interface 205. The user interface manager 202 may further gather status information, including completion status, error conditions, error resolution or remedial actions, and present the same on the user interface 205. Based on input from the user interface 205, the user interface manager 202 may cause various actions to take place, including remedial actions, as well as reconfigure the user interface 202 to present more or less information regarding the workloads.

The user interface manager 202 may direct the operation of other elements of the installation system based on input from a user. For example, the user interface manager 202 may be used to cause a workload gatherer 204 to identify various workloads to operate.

The workload gatherer 204 may gather various workloads together prior to execution of the workloads. In many systems, a workload may be defined for the installation or configuration of a single component, such as a hardware device, software application, or service. The workload may comprise multiple tasks, and each task may have various input parameters and may generate results.

The workloads may conform to a workload schema 203. The workload schema 203 may define a common mechanism for identifying, classifying, and executing various workloads. The workload schema 203 may enable workloads developed by different software or hardware manufacturers to be managed and executed by the installation system of embodiment 200.

In some embodiments, complex installations of a single component may be broken down into multiple workloads. Such an embodiment may be useful for cases where multiple components have interdependencies. For example, a first service may be partially installed using a first workload, then an application that interacts with the service may be installed using a second workload. Finally, a third workload may finalize the configuration of the first service using configuration results from the application installation.

In some embodiments, the workload gatherer 204 may identify workloads that have already been completed or workloads that have been partially completed. Completed workloads may be useful for identifying results that may be used by other workloads. For example, a widely used service, such as a messaging service, may have configuration parameters that are used by many other applications. By identifying the completed configuration workload for the messaging service, the workload gatherer 204 may identify some input parameters that may be used by subsequent workloads for related applications.

In some cases, a workload may have been started but not successfully completed. The workload gatherer 204 may identify those workloads and may present the partially completed workloads in the user interface 205. A user may be able to select one or more of the partially completed workloads for execution.

After workloads are identified for execution, the sequencer 206 may organize the workloads and tasks within those workloads in sequential order. In many embodiments, the input parameters for one workload may be the results of another workload. Other dependencies may be defined within the workload or through an external database that may have dependency definitions.

The sequencer 206 may create a sequence of workloads to execute. In many embodiments, the sequence may be a linear sequence. In other embodiments, the sequence may include portions where two or more workloads may be executed in parallel.

Some embodiments may generate sequences based on individual tasks within the workloads. In such a case, the sequencer 206 may generate a sequence of tasks, and the tasks from one workload may be interspersed with tasks from other workloads. For example, during the installation of two services that are highly interdependent, a first task may be performed for the first service, a second task performed for the second service, a third task performed for the first service, and a fourth task performed for the second service.

Prior to executing the various workloads and tasks, the input parameters for the tasks may be identified and populated by a data populator 214. Input parameters may be populated by an environmental scanner 210 that may scan the local hardware and software, as well as the hardware and software from other devices connected through a local area network or a wide area network such as the Internet. The environmental scanner 210 may populate a status database 212 that may be used to populate the input parameters for the various tasks.

For those input parameters that are not available through the status database 212 or for which a result of another task is not available, the data populator 214 may query the input parameters to the user through the user interface 205 and the values stored in the status database 212.

In many embodiments, such input parameters may be queried prior to beginning execution of the tasks. By consolidating the queries, an administrator may enter the data prior in a short session prior to launching a time consuming installation sequence. In some embodiments, an installation sequence may take several hours to complete.

In some embodiments, some input parameters may be queried at various stages during the execution of the workloads.

After the sequencer 206 has determined the sequence, the execution mechanism 208 may cause the various tasks to be executed. The tasks may be executed using any mechanism.

In some cases, a task may be executed by causing a short executable program to be run. In other cases, execution mechanism may have an environment capable of executing scripts, communicating with different applications, or performing other activities that perform the operations of a task.

During task execution, an error resolution database 216 may be employed to identify and correct problems that may occur. The error resolution database 216 may contain rules, logic, or other information that may be used to identify corrective or remedial action that may be taken when a specific error occurs. For example, an error may be detected and one or more options for resolving the condition may be identified through the error resolution database 216. One or more options may be identified that may resolve the condition. In some cases, the sequence may be paused and one or more options presented to a user. In other cases, the resolution of the condition may be identified and automatically executed without user interaction.

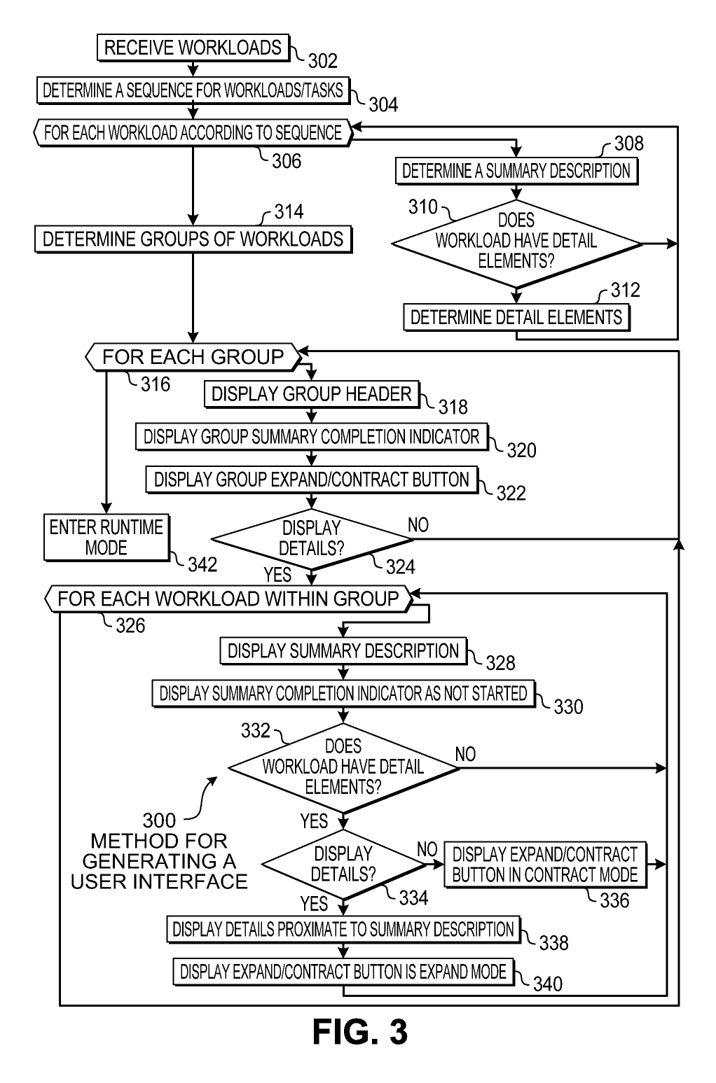

FIG. 3 is a flowchart illustration of an embodiment 300 showing a method for generating a user interface. Embodiment 300 is a simplified method for generating a user interface that can be used for monitoring and managing workloads as those workloads are processed.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

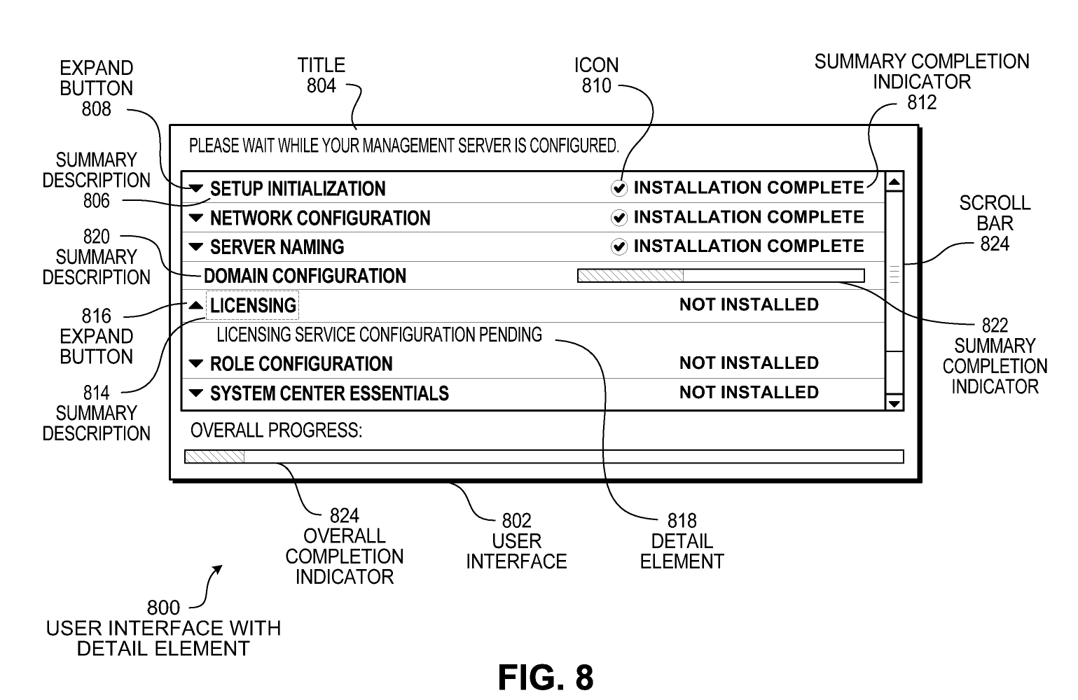

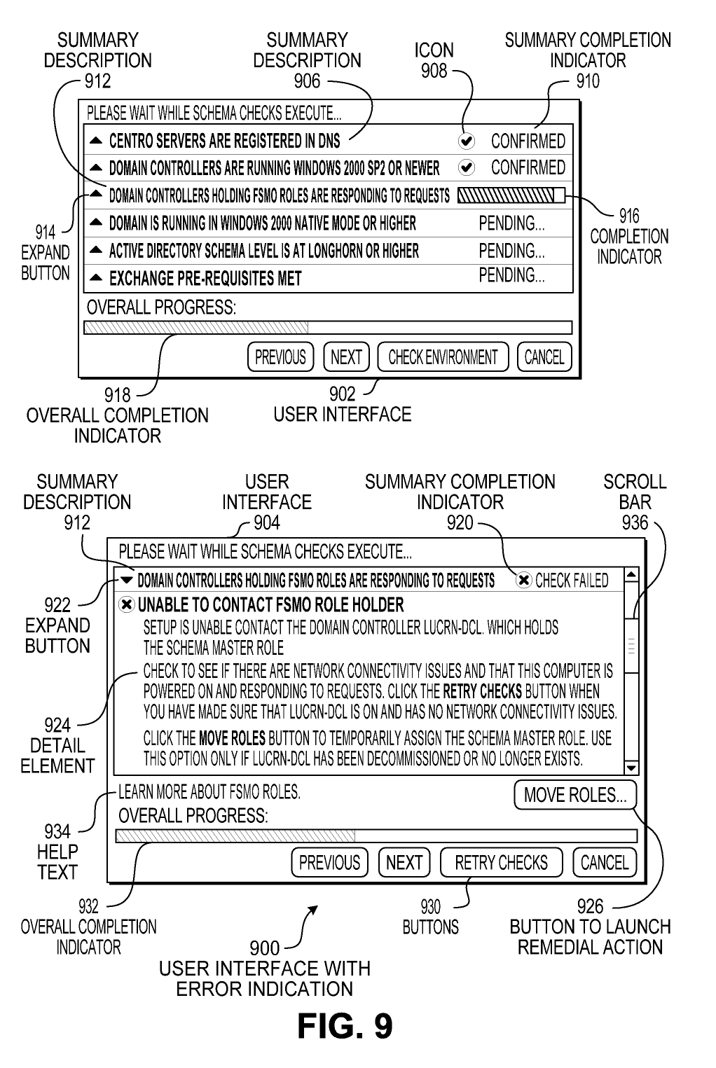

Embodiment 300 is an example of a method by which a user interface manager, such as user interface manager 202, may construct a user interface. Examples of such user interfaces may be seen in FIGS. 8 and 9 of this specification.

In the method of embodiment 300, a user interface manager may gather together the information to be displayed, and then creates a user interface based on that information. The displayed information include summary and detailed descriptions of the various workloads and tasks that are to be performed. In some embodiments, each workload may be individually displayed while in other embodiments, each task within each workload may be individually displayed.

The user interface may display a workload or task in an expanded or contracted mode. In an expanded mode, details about a workload or task may be shown. In a contracted mode, the details may be hidden. A user may be able to toggle or otherwise change between an expanded or contracted mode of display.

Workloads may be received in block 302. The workloads may be gathered by any mechanism. In some embodiments, such as embodiment 200, the workloads may be gathered by the workload gatherer 204.

A sequence for the workloads or tasks may be determined in block 304. In some embodiments, a workload may consist of many individual tasks, and each task may be sequenced with respect to other tasks in other workloads. In other embodiments, a sequence of workloads may be determined without analyzing individual tasks. Different embodiments may have different criteria for determining a sequence and may employ different methods for determining a sequence.

Each workload is analyzed in block 306. For the example of embodiment 300, a workload is the most granular element displayed on the user interface. In other embodiments, the various tasks within each workload may be the most granular element displayed in the user interface. The example of embodiment 300 illustrates the concept as applied to workloads, and other embodiments may apply the same principles and techniques to individual tasks.

For each workload in block 306, a summary description may be determined in block 308. The summary description may be a short, text-based description of a workload. In some embodiments, a graphic image may be used to represent the workload, and some embodiments may use a combination of text-based descriptors and graphic images as a summary description.

In some cases, a summary description may be defined within the workload or task represented by the summary description. For example, a description file for the workload or task may include a parameter or variable that includes a summary description.

In some cases, a summary description may be determined from analyzing various sources of information. For example, a file name of a workload definition may be used. In some cases, a database of summary descriptions may be queried to determine a summary description.

If the workload has detailed elements in block 310, the detail elements are determined in block 312. The detail elements may be determined in a similar manner as the summary description.

The detail elements may contain a more detailed description of the operations performed by the workload, for example. Other detail elements may include the software manufacturer of the workload, version number, or any other metadata or descriptors of the workload.

After gathering information for each workload in the sequence in block 306, the workloads may be grouped in block 314.

In some embodiments, related workloads may be grouped together. By defining groups, the workloads may displayed together and summary statistics may be generated for the grouped workloads.

For each group in block 316, the group of workloads may be displayed. In block 318, a group header may be displayed, along with a group summary completion indicator in block 320. A group expand/contract button may be displayed in block 322.

The group header may include a short description, name, icon, image, or some other identifier of the group. In many embodiments, a group header may be presented in a visually highlighted manner using shading, colors, type face, type size, or other visual mechanisms to illustrate the group separate from a workload or other displayed element, for example.

The group may have an expand/contract button in block 322. The expand/contract button may be a toggle that may expand the display to show the workloads that make up the group, or contract to hide the individual workloads. Some embodiments may have different user input mechanisms for showing or hiding details. In the examples shown in FIGS. 8 and 9, a toggle button user interface mechanism is illustrated. When the button is expanded, the button may have one icon and when the button is contracted, the button may have a different icon. The user may toggle the button by clicking on the button using a pointing device, for example.

If the group is not selected to display details in block 324, the process may return to block 316 so that the next group may be processed.

If the group is selected to display details in block 324, for each workload within the group in block 326, a summary description may be displayed in block 328 and a summary completion indicator may be displayed as not started in block 330.

The summary description of block 328 may be the same summary description determined in block 308.

A summary completion indicator of block 330 may be any indicator for the completion status. Since the embodiment 300 may represent the initial construction of a user interface, the action of block 330 may presume that the workload has not yet been executed. In some cases, the workload may have been completed or partially completed. If such is the case, the summary completion indicator of block 330 may so indicate.

If the workload has detail elements in block 332, but the details are not to be displayed in block 334, an expand/contract button may be displayed in the contracted mode.

If the workload has detail elements in block 332 and the details are to be displayed in block 334, the details may be displayed proximate to the summary description in block 338 and the expand/contract button may be displayed in the expanded mode in block 340.

Whether details of a workload are to be displayed in block 334 may be determined by preferences for the user interface manager, may be included in the workload definition, or may be determined by other mechanisms.

After each group is processed in block 316, runtime mode may be entered in block 342.

The expand/contract buttons described in blocks 322, 336, and 340 may be any user interface mechanism by which the state of the detail display of a workload or group are indicated. In many graphical user interfaces, a button may be a user input device as well. In some embodiments, an indicator may be displayed but a different mechanism may be used for receiving user input, such as a keyboard or some other mechanism. Various embodiments may use different display and input mechanisms for the display and input functions performed by the buttons as illustrated in FIGS. 8 and 9.

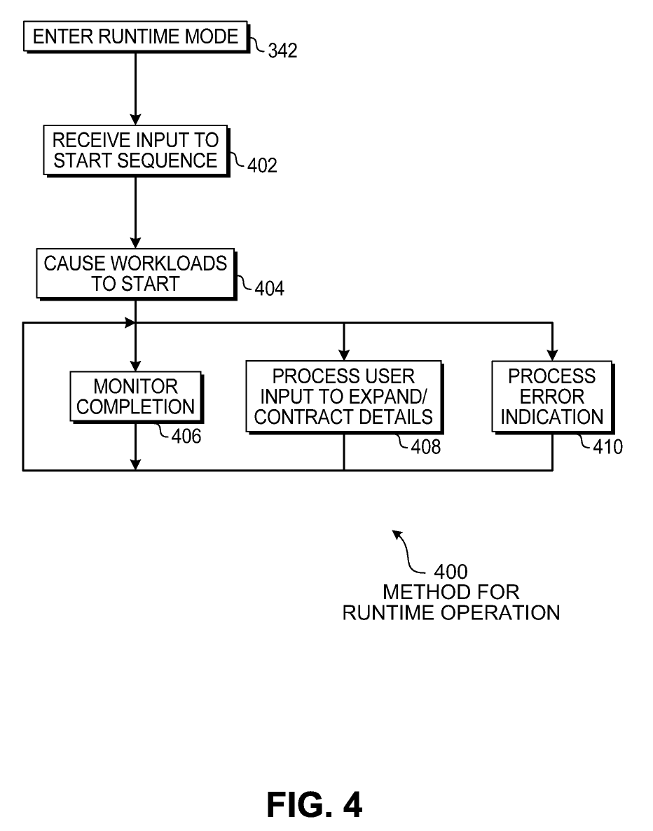

FIG. 4 is a flowchart illustration of an embodiment 400 showing a runtime method for using and updating a user interface. Embodiment 400 is a simplified method for operating a user interface such as the user interface created in embodiment 300.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of a method that may be used after a display is created for monitoring and managing the execution of workloads. Embodiment 400 may begin by entering runtime mode of block 342.

An input may be received in block 402 to start the sequence, and one or more workloads may be caused to be started in block 404.

In some embodiments, workloads or tasks may be executed in series, with one workload being executed at a time. In other embodiments, workloads or tasks may be executed in parallel, with two or more workloads being executed at a time.

While the workloads are being executed, a user interface manager may perform three functions in parallel. The functions include monitoring the completion of workloads in block 406, processing user input to expand and contract details in block 408, and processing error indications in block 410.

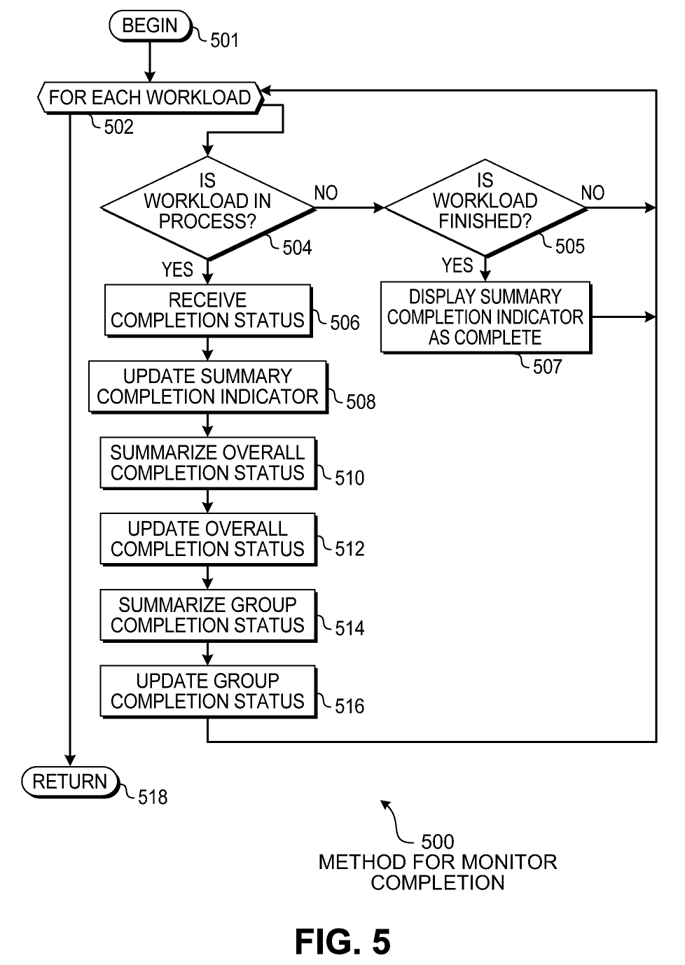

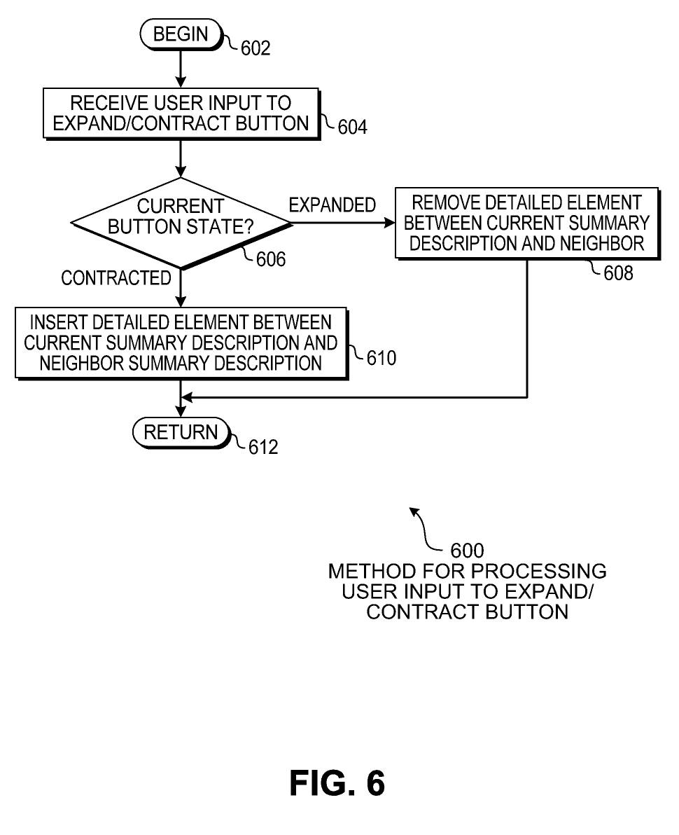

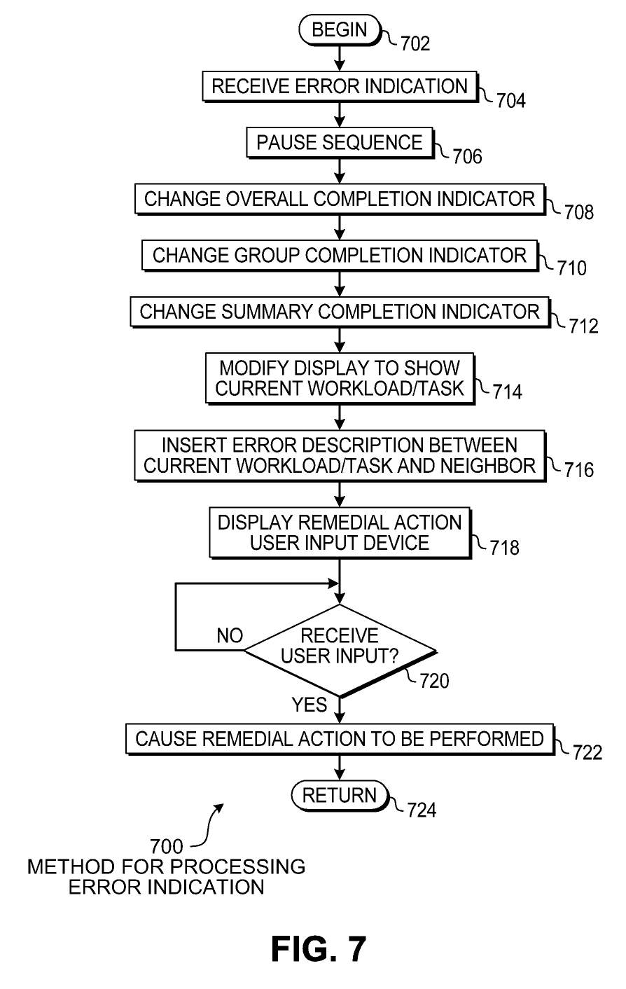

An example method of monitoring workloads is illustrated in FIG. 5. An example method of processing user input for expanding and contracting details is illustrated in FIG. 6, and an example method of processing error indicators is illustrated in FIG. 7.

FIG. 5 is a flowchart illustration of an embodiment 500 showing a method for monitoring completion of workloads. Embodiment 500 is a simplified method for analyzing and displaying the completion of workloads.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is an example of a method for continually monitoring and updating the status of a workload, a group of workloads, and the overall completion status.

Embodiment 500 begins in block 501. For each workload in block 502, if the workload is not in process in block 504, and the workload is not finished in block 505, the method returns to block 502.

If the workload is not in process in block 504 and the workload is finished in block 505, the summary completion indicator is displayed as complete in block 507.

If the workload is in process in block 504, a completion status may be received in block 506. In some embodiments, a query may be made to an executing workload to determine the completion status. In other embodiments, the executing workload may send a message to an installation system to periodically update the status of a workload.

In some embodiments, an installation system may estimate the completion status. For example, a workload may take approximately 60 seconds to complete. The installation system may start a timer when the workload begins and may estimate that the completion status is approximately the elapsed time divided by the estimated completion time. In the example, at 45 seconds after the workload started, the workload may be estimated to be 75% complete. Other embodiments may use different methods for estimating or gathering actual completion status.

After receiving a completion status in block 506, the summary completion indicator displayed for the workload may be updated in block 508.

The overall completion status may be summarized in block 510 and the display updated in block 512. The overall completion status may be a completion indicator that illustrates or states the progress of the entire set of workloads. In many embodiments, the progress may be indicated by a progress bar, an estimated amount of time remaining, a percentage completion indicator, or some other mechanism.

In many embodiments, the completion status and completion indicators may be estimates of the amount of work to complete or the remaining time. In some embodiments, such estimates may be rather imprecise.

In a similar manner as updating the overall completion status in block 510, a group completion status may be summarized in block 514 and displayed in block 516. The group completion status may be used to illustrate the status of the subset of workloads defined in the group.

After each workload is processed in block 502, the method may return in block 518.

FIG. 6 is a flowchart illustration of an embodiment 600 showing a method for processing user input to an expand/contract button. Embodiment 600 is a simplified method for expanding and contracting a detailed section of a user interface based on a toggle type input button.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 is an example of a method for expanding and contracting a detail element of a user interface. A visual example of such an action is illustrated in FIG. 9. The method of embodiment 600 may be performed during the runtime phase of a user interface. In response to a user input, a detailed element is displayed or removed from the user interface.

Embodiment 600 may begin in block 602.

User input may be received in block 604 through an expand/contract button. An example of an expand/contract button is illustrated in FIG. 9. Other embodiments may use any type of user input mechanism through which a user may indicate that a detail element may be added or removed from a user interface. In many cases, an expand/contract button may be proximate to or near a summary description for the workload.

If the current state of the expand/contract indicator is expanded in block 606, a detail element may be removed from the user interface in block 608. The detail element may be removed from between a workload's summary description and a neighboring summary description.

If the current state of the expand/contract indicator is contracted in block 606, a detail element may be inserted on the user interface in block 610 between a workload's summary description and a neighboring summary description.

After the user interface is updated in either block 608 or 610, the method may return in block 612.

The detail element of embodiment 600 may be any type of detailed information that may be displayed along with a workload or task. Examples of a detail element may be a listing of specific operations performed by a workload or one or more sentence description of the workload.

In some embodiments, an animated action may be used to smoothly separate the two workloads and insert the detail element between the workloads.

FIG. 7 is a flowchart illustration of an embodiment 700 showing a method for processing error indications. Embodiment 700 is a simplified method for processing an error indication by interrupting a sequence of workloads, displaying a description of an error condition, and presenting at least one remedial action that may be taken.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 700 is an example of how a user interface may be changed in response to an error indication.

Embodiment 700 may begin in block 702.

An error indication may be received in block 704. An error indication may be received by any mechanism by which an error within a workload can be communicated to a user interface manager. An error may be indicated by a message, an interrupt, or any other mechanism.

After receiving the error indication in block 704, the sequence may be paused in block 706. In embodiments where multiple workloads may processed in parallel, a workload that generated the error indication may be paused while the other workloads continue. In other embodiments with multiple workloads may be processed in parallel, all workloads may be paused. In embodiments where workloads are processed serially, the current workload may be paused in block 706, which would be the workload for which an error may be received in block 704.

The overall completion indicator may be changed in block 708, as well as the group completion indicator in block 710, and the summary completion indicator in block 712. In blocks 708, 710, and 712, the various completion indicators may be changed from a processing status to a paused status.

In some embodiments, a progress bar may be used as a completion indicator, and during normal processing the progress bar may be shown in green color. When the completion indicators are changed in blocks 708, 710, and 712, the progress bars may be changed to red to indicate that the process has stopped. In other embodiments, some other indicator of a stopped status may be displayed and previous indicators of an ongoing process may be removed.

The display may be modified to show the current workload or task in block 714. In many cases, several workloads may be managed by a user interface manager but a subset of the workloads may be displayed at one time. In an example of such a case, a scroll bar may be used to scroll up and down through a list and one or more workloads may be outside the subset of displayed workloads.

In block 714, the user interface may be scrolled or otherwise modified so that the current workload or task is visually displayed. In many cases, the current workload or task may be prominently displayed by placing the current workload or task at the top of a list of workloads.

An error description may be inserted between the current workload and a neighboring workload in block 716. In many embodiments, the insertion of the error description may be done in a similar manner as the insertion of a detail element in embodiment 600.

A remedial action may be displayed with a user input device in block 718. In many cases, two or more remedial actions may be presented. In an example, a button may be presented on the user interface. In another example, a highlighted link may be presented. In such examples, the user input device may be link to or otherwise cause the remedial action to be launched. In some cases, the error description of block 716 may describe steps that may be taken outside of the user interface to remedy a problem, and a button or other user input mechanism may be used to restart or continue the current workload.

In many embodiments, the error description inserted in block 716 may include a description of and recommendations for remedial actions to be taken. Such descriptions and recommendations may come from an error resolution database, such as the error resolution database 216 of embodiment 200.

When user input is received in block 720, the remedial action may be launched or otherwise caused to be performed in block 722. Until the user input is received, the workload may be paused.

FIG. 8 is an illustration of an example embodiment 800 showing a user interface with a detail element. Embodiment 800 is an example user interface selected to illustrate some components that may be present in a user interface. Other embodiments may have a different look and feel, and different arrangements of the various elements.

Embodiment 800 shows a list of several workloads as defined by their summary descriptions. The workloads are illustrated in a top-down configuration, with the first workload performed at the top. Other embodiments may arrange the workloads from side to side or from bottom to top in sequence.

The user interface 802 may be a window or other graphical user interface element as may be displayed on a monitor or other display device. The user interface 802 may have a title 804 that gives a brief description of the process being performed, and may have multiple summary descriptions, such as summary description 806, 814, and 820.

Summary description 806 may illustrate the summary description for a single workload or task. An expand button 808 may be actuated to display a detail element. The presence of the expand button 808 near the summary description 806 shows that a detail element is available. In contrast, summary description 820 is shown with no expand button which may indicate that no detail element is available for summary description 820.

Summary description 806 has a summary completion indicator 812 that reads “Installation Complete”. Also, icon 810 may be illustrated with a check mark icon indicating completion.

Summary description 814 illustrates a summary description with a detail element 818. The detail element 818 may have a short text description of the workload related to the summary description 814.

The expand button 816 may be illustrated in a contract mode, which is in contrast to the expand button 808 illustrated in the expand mode. When a user may toggle the expand button 816, the detail element 818 may be removed from the user interface 802 and the neighboring summary description may be moved closer to the summary description 814.

Summary description 820 may illustrate a workload currently being processed. A summary completion indicator 822 is a progress bar that appears to show about 25% completion.

An overall completion indicator 824 may illustrate the relative completion of all of the workloads. Overall completion indicator 824 may illustrate that approximately 10% of the workloads have been completed.

The user interface 802 has a scroll bar 824 that may be used to scroll downward to show other summary descriptions for workloads in the sequence.

FIG. 9 is an illustration of an example embodiment 900 showing a user interface before and after an error indication is processed. Embodiment 900 is an example user interface selected to illustrate some components that may be present in a user interface. Other embodiments may have a different look and feel, and different arrangements of the various elements.

Embodiment 900 shows a user interface 902 prior to receiving an error indication and user interface 904 which may illustrate the changes to user interface 902 after the error indication is processed. A method for processing an error indication was described in embodiment 700.

The user interface 902 have a summary description 906 that may include an icon 908 and a summary completion indicator 910. Summary description 906 may illustrate that the workload associated with summary description 906 is complete.

Summary description 912 is illustrated as being in process. An expand button 914 may be illustrated in the contracted state, and the completion indicator 916 may be a progress bar showing about ⅔ complete. An overall completion indicator 918 may be shown as about 40% complete.

The user interface 904 may illustrate how the user interface 902 may be changed when an error indication is received. In user interface 904, the summary description 912 may be moved to the top of the list of workloads, and a scroll bar 936 may be added to indicate that additional summary descriptions may be hidden from view.

The summary completion indicator 920 may replace the summary completion indicator 916. Instead of the progress bar of completion indicator 916, a stop sign icon and a “Check Failed” text may be shown.

Underneath the summary description 912, a detail element 924 may be inserted that describes the error condition may contain instructions for remedying the error condition.

A button 926 may be added that may launch a remedial action. Some help text 934 may be hyperlinked to a website or some other, more detailed explanation of the context of the error condition. The buttons 930 may be used to continue, cancel, or retry the workload or sequence of workloads. In some cases, the buttons 930 may enable a user to skip the current workload and proceed with the next workload in sequence.

The overall completion indicator 932 may be changed from the overall completion indicator 918. While the process is properly performing, the overall completion indicator 918 may be displayed in green. When the process is paused in user interface 904, the overall completion indicator 932 may be shown in red.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a plurality of workloads, each of said workloads comprising at least one task, said task comprising a task definition conforming to a task schema;
determining a sequence of said tasks;
displaying a summary description for each of said workloads in a user interface, said summary descriptions being arranged according to said sequence;
displaying a completion indicator for each of said workloads proximate to said summary description;
causing said workloads to be performed according to said sequence and while said workloads are being performed, updating said completion indicator and determining a summary completion indicator based on said completion indicator for each of said workloads;
receiving a first user input proximate to a first summary description, said first summary description relating to a first workload; and
inserting at least one detail element between said first summary description and a second summary description, said second summary description relating to a second workload, said second workload being adjacent to said first workload according to said sequence.

2. The method of claim 1, said first user input comprising toggling an expand button.

3. The method of claim 1, said at least one detail element comprising at least one description of at least one of said tasks.

4. The method of claim 3, said at least one detail element further comprising a completion indicator for said one of said tasks.

5. The method of claim 3, said at least one detail element comprising at least one error description.

6. The method of claim 5 further comprising:
inserting a second detail element between said first summary description and said second summary description, said second detail element relating to at least one user input mechanism configured to cause a remedial action to be performed.

7. The method of claim 1, said at least one detail element comprising at least one result from said first workload.

8. The method of claim 1, at least one of said workloads defining an installation mechanism for a software component.

9. The method of claim 8, said software component being installed on a remote device.

10. The method of claim 9, said updating said completion indicator being performed based on passively receiving data from said remote device.

11. The method of claim 9, said updating said completion indicator being performed based on actively querying said remote device.

12. The method of claim 1, said inserting comprising animating a motion separating said first summary description and said second summary description.

13. A system comprising:
a workload gathering mechanism configured to receive a plurality of workloads, each of said workload comprising at least one task;
a sequencing mechanism configured to identify at least one dependency between a first workload and a second workload, and determine a sequence for said workloads using said at least one dependency; and
a user interface manager configured to perform a method comprising:
displaying a summary description for each of said workloads in a user interface, said summary descriptions being arranged according to said sequence;
displaying a completion indicator for each of said workloads proximate to said summary description;
when said workloads are performed according to said sequence, updating said completion indicator and determining a summary completion indicator based on said completion indicator for each of said workloads;
receiving a first user input proximate to a first summary description, said first summary description relating to a first workload; and
inserting at least one detail element between said first summary description and a second summary description, said second summary description relating to a second workload, said second workload being adjacent to said first workload according to said sequence.

14. The system of claim 13 further comprising:
a fault management system configured to receive an error from one of said tasks; and
said detail element comprising at least one reference to said error.

15. The system of claim 14, said fault management system further configured to:
determine a remedial action in response to said error;
said detail element further comprising a user input mechanism configured to cause said remedial action to occur.

16. The system of claim 15, said fault management system further configured to:
determine a plurality of said remedial actions in response to said error;
said detail element further comprising a plurality of said user input mechanisms, each of which being configured to cause one of said remedial actions to occur.

17. A method comprising:
receiving a plurality of workloads, each of said workloads comprising at least one task;
determining a sequence of said tasks;
displaying a summary description for each of said tasks in a user interface, said summary descriptions being arranged according to said sequence;
displaying a completion indicator for each of said tasks proximate to said summary description;
causing said tasks to be performed according to said sequence and while said tasks are being performed, updating said completion indicator and determining a summary completion indicator based on said completion indicator for each of said tasks;
receiving a first user input proximate to a first summary description, said first summary description relating to a first task; and
inserting at least one detail element between said first summary description and a second summary description, said second summary description relating to a second task, said second task being adjacent to said first task according to said sequence.

18. The method of claim 17 further comprising:
grouping said tasks according to said workloads.

19. The method of claim 18 further comprising:
displaying a workload summary description for at least one of said workloads.

20. The method of claim 18 further comprising:
receiving a second user input proximate to a first workload summary description, said first workload summary description relating to a first workload; and
removing at least one summary description for at least one task comprised in said workload.
